(19) United States
(12) Patent Application Publication
(10) Pub. No.: US 2025/0004808 A1
(43) Pub. Date: Jan. 2, 2025

(54) PLACEMENT IN A VIRTUALIZED COMPUTING ENVIRONMENT BASED ON RESOURCE ALLOCATION

(71) Applicant: VMware LLC, Palo Alto, CA (US)

(72) Inventors: Daniel Pavlov, Sofia (BG); Mihail Mihaylov, Sofia (BG); Jose Francisco Dillet Alfonso, Plovdiv (BG); Petar Mitrov, Sofia (BG); Atanas Shindov, Sofia (BG)

(73) Assignee: VMware LLC, Palo Alto, CA (US)

(21) Appl. No.: 18/217,118

(22) Filed: Jun. 30, 2023

(51) Int. Cl. G06F 9/455

(52) U.S. Cl. CPC G06F 9/45558; G06F 2009/4557

(57) ABSTRACT

The present disclosure is related to devices, systems, and methods for placement in a virtualized computing environment based on resource allocation. One embodiment includes instructions to receive a request made by a customer to create a virtual computing instance (VCI) of a project in cloud computing environment and place the VCI.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for placement in a virtualized computing environment based on resource allocation according to one or more embodiments of the present disclosure.

FIG. 2 is a diagram of a system for placement in a virtualized computing environment based on resource allocation according to one or more embodiments of the present disclosure.

FIG. 3 is a diagram of a machine for placement in a virtualized computing environment based on resource allocation according to one or more embodiments of the present disclosure.

### DETAILED DESCRIPTION

As referred to herein, a virtual computing instance (VCI) covers a range of computing functionality. VCIs may include non-virtualized physical hosts, virtual machines (VMs), and/or containers. A VM refers generally to an isolated end user space instance, which can be executed within a virtualized environment. Other technologies aside from hardware virtualization that can provide isolated end user space instances may also be referred to as VCIs. The term “VCI” covers these examples and combinations of different types of VCIs, among others. VMs, in some embodiments, operate with their own guest operating systems on a host using resources of the host virtualized by virtualization software (e.g., a hypervisor, virtual machine monitor, etc.).

Multiple VCIs can be configured to be in communication with each other in an SDDC. In such a system, information can be propagated from a client (e.g., an end user) to at least one of the VCIs in the system, between VCIs in the system, and/or between at least one of the VCIs in the system and a server. SDDCs are dynamic in nature. For example, VCIs and/or various application services, may be created, used, moved, or destroyed within the SDDC. When VCIs are created, various processes and/or services start running and consuming resources. As used herein, “resources” are physical or virtual components that have a finite availability within a computer or SDDC. For example, resources include processing resources, memory resources, electrical power, and/or input/output resources.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

When a user (e.g., a customer) triggers the creation of a new VCI, a determination of where to place the VCI is made. This determination is referred to herein as “placement” and can involve the determination of which cloud zone (from among a plurality of cloud zones) and which cluster (from among a plurality of clusters) in which to place the VCI. Placement may be carried out according to a placement policy (discussed further below). As known to those of skill in the art, a cluster is a group of hosts. A cloud zone (sometimes referred to herein simply as “zone”) may be defined as a group of clusters plus configuration. A cloud zone may be defined as a set of resources within a cloud account type (e.g., Amazon Web Services (AWS), vSphere, etc.). A cloud zone may be associated with (e.g., linked to) a particular geographic region. A project, as referred to herein, may be defined as a group of cloud zones plus configuration. A project can determine the cloud zone(s) on which a set of users or groups can deploy workloads, a priority value, the maximum number of VCIs to deploy, and a maximum amount of memory that the deployment can use. A project may be defined by using an organizational structure, such as a cost-center, or a specific business group or purpose.

Where to place a new VCI can be determined by a development platform. A development platform can be used to configure and/or provision resources in a virtualized environment. One example of such a development platform is vRealize Automation (vRA). vRA is a cloud management layer that sits on top of different clouds. It can provision complex deployments and offer governance and management of these workloads and the resources in the cloud. vRA can support public and/or private clouds. vCenter (vSphere) is one of the private clouds that vRA supports. A development platform can determine where to place a new VCI in accordance with a placement policy. A placement policy is a rule that dictates how the development platform (e.g., an allocation engine of a development platform) should determine where to place a new VCI. Though the example of vRA is discussed herein, embodiments of the present disclosure are not so limited. A development platform in accordance with the present disclosure can be designed to automate multiple clouds with secure, self-service provisioning.

Provisioning may be necessarily associated with a particular project, so with that determination already made, the development platform then determines which cloud zone and which cluster to choose for the new VCI. In previous approaches, three placement policies were commonly supported: default, spread, and binpack. According to the default policy, VCIs are placed in the first applicable zone and cluster. According to the spread policy, VCIs are spread based on their count. According to the binpack approach, VCIs are placed on the most loaded cluster. However, the policies of previous approaches may not be adequate or suitable for particular use cases. Some users, for instance, may desire to provision VCIs of different sizes. Previous approaches may not allow for optimal usage of resources in such a scenario. Some users may desire for clusters to be equally loaded (e.g., for performance), which previous approaches may not allow.

Embodiments of the present disclosure allow the spread (e.g., placement) of VCIs by resource type. For instance, VCIs can be placed based on memory, virtual processing (e.g., number of virtual central processing units (CPUs)), and/or storage. Stated differently, embodiments herein provide three placement policies, “spread by memory,” “spread by CPU,” and “spread by storage.” These policies can be set on two different levels: in a project and in a cloud zone. The placement policy in the project dictates how a cloud zone is chosen for the new VCI from among the zones in the project. The placement policy in the cloud zone dictates how a cluster is chosen for the new VCI from among the clusters in the cloud zone. The determinations for each of the two levels are done separately. Accordingly, a user can elect one type of policy in the project and another type of policy in the cloud zone. It is to be understood that the same type of policy can be used in both the project and the cloud zone levels.

In some instances, a project may include multiple zones, some of which are linked to a public cloud and some of which are linked to a private cloud. This complicates placement because private cloud zones have a finite amount of resources while public clouds can be potentially unlimited. Using a standard comparison in such a scenario would lead to the selection of the public cloud zone for placement because it has more free resources compared to the private cloud zone. Users desiring to have their VCIs spread equally between private and public clouds for better availability (e.g., high availability (HA)), may be frustrated. Embodiments of the present disclosure can place within the private cloud based on the amount of free resources (which are known to the development platform (total resources minus allocated resources equals free resources)), and can place within the public cloud based on the amount of allocated resources (as total size may be unknown to the development platform).

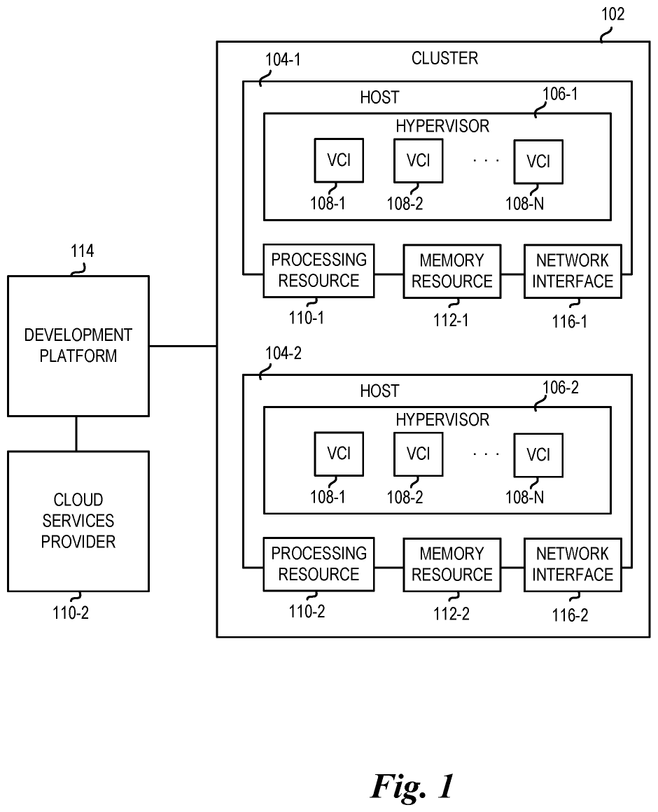

FIG. 1 is a diagram of a host and a system for placement in a virtualized computing environment based on resource allocation according to one or more embodiments of the present disclosure. The system can include a cluster 102 in communication with a development platform 114. The cluster 102 can include a first host 104-1 with processing resources 110-1 (e.g., a number of processors), memory resources 112-1, and/or a network interface 116-1. Similarly, the cluster 102 can include a second host 104-2 with processing resources 110-2, memory resources 112-2, and/or a network interface 116-2. Though two hosts are shown in FIG. 1 for purposes of illustration, embodiments of the present disclosure are not limited to a particular number of hosts. For purposes of clarity, the first host 104-1 and/or the second host 104-2 (and/or additional hosts not illustrated in FIG. 1) may be generally referred to as “host 104.” Similarly, reference is made to “hypervisor 106,” “VCI 108,” “processing resources 110,” memory resources 112,” and “network interface 116,” and such usage is not to be taken in a limiting sense.

The host 104 can be included in a software-defined data center. A software-defined data center can extend virtualization concepts such as abstraction, pooling, and automation to data center resources and services to provide information technology as a service (ITaaS). In a software-defined data center, infrastructure, such as networking, processing, and security, can be virtualized and delivered as a service. A software-defined data center can include software-defined networking and/or software-defined storage. In some embodiments, components of a software-defined data center can be provisioned, operated, and/or managed through an application programming interface (API).

The host 104-1 can incorporate a hypervisor 106-1 that can execute a number of VCIs 108-1, 108-2, . . . , 108-N (referred to generally herein as “VCIs 108”). Likewise, the host 104-2 can incorporate a hypervisor 106-2 that can execute a number of VCIs 108. The hypervisor 106-1 and the hypervisor 106-2 are referred to generally herein as a hypervisor 106. The VCIs 108 can be provisioned with processing resources 110 and/or memory resources 112 and can communicate via the network interface 116. The processing resources 110 and the memory resources 112 provisioned to the VCIs 108 can be local and/or remote to the host 104. For example, in a software-defined data center, the VCIs 108 can be provisioned with resources that are generally available to the software-defined data center and not tied to any particular hardware device. By way of example, the memory resources 112 can include volatile and/or non-volatile memory available to the VCIs 108. The VCIs 108 can be moved to different hosts (not specifically illustrated), such that a different hypervisor manages (e.g., executes) the VCIs 108. The cluster 102 can be in communication with a development platform 114. As previously discussed, the development platform 114 can be vRA, though embodiments of the present disclosure are not so limited. In some embodiments, the development platform 114 can be a server, such as a web server. The development platform 114 can include computing resources (e.g., processing resources and/or memory resources in the form of hardware, circuitry, and/or logic, etc.) to perform various operations, as described in more detail herein. The development platform 114 can be in communication with a cloud service provider 116. In some embodiments, the cloud service provider 116 can provide services of a public cloud (e.g., AWS, Microsoft Azure, etc.). In some embodiments, the cloud service provider 116 can provide services of a private cloud (e.g., vSphere). It is noted that while one cloud service provider 116 is shown in FIG. 1, embodiments of the present disclosure can include more than one cloud service provider 116.

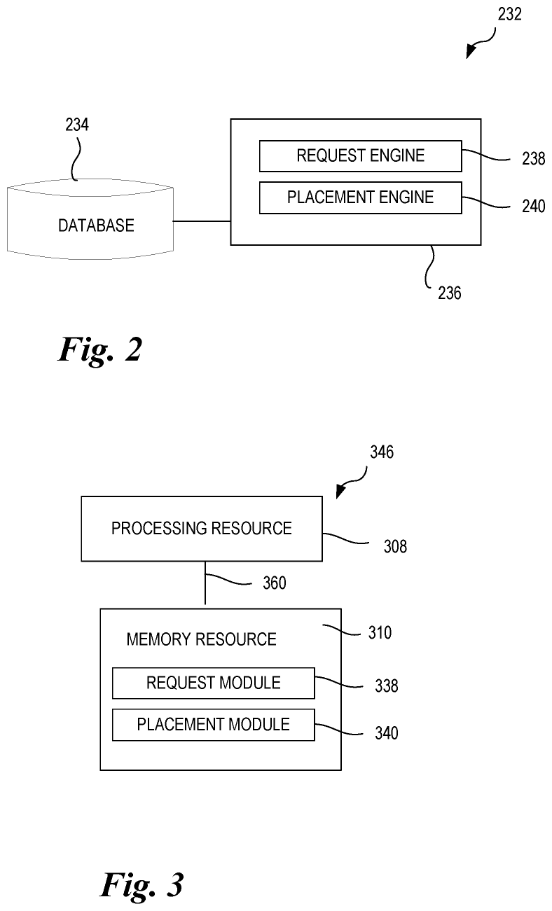

FIG. 2 is a diagram of a system 232 for placement in a virtualized computing environment based on resource allocation according to one or more embodiments of the present disclosure. The system 232 can include a database 234, a subsystem 236, and/or a number of engines, for example request engine 238 and/or placement engine 240, and can be in communication with the database 234 via a communication link. The system 232 can include additional or fewer engines than illustrated to perform the various functions described herein. The system can represent program instructions and/or hardware of a machine (e.g., machine 346 as referenced in FIG. 3, etc.). As used herein, an “engine” can include program instructions and/or hardware, but at least includes hardware. Hardware is a physical component of a machine that enables it to perform a function. Examples of hardware can include a processing resource, a memory resource, a logic gate, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the request engine 238 can include a combination of hardware and program instructions that is configured to receive a request made by a customer to create a virtual computing instance (VCI) of a project in cloud computing environment. In some embodiments, the placement engine 240 can include a combination of hardware and program instructions that is configured to place the VCI.

In embodiments where zones are linked to a public cloud (e.g., and not a private cloud), the placement engine 240 can include a combination of hardware and program instructions that is configured to determine the cloud computing environment is a public cloud computing environment. Responsive to such a determination, the placement engine 240 can include a combination of hardware and program instructions that is configured to determine a respective amount of a resource allocated to the customer in each of a plurality of cloud zones of the cloud computing environment, determine a placement cloud zone of the cloud computing environment, wherein the placement cloud zone has a least amount of the allocated resource from among the plurality of cloud zones, determine a respective amount of the resource allocated to the customer in each of a plurality of clusters of the placement cloud zone, and place the VCI in a cluster of the placement cloud zone having a least amount of the allocated resource from among the plurality of clusters.

Stated differently, the placement engine 240 can place VCIs by resource type (e.g., memory, CPU, and/or storage) in a public cloud environment, first in the project by selecting a zone having the least amount of an allocated resource. In some embodiments, for instance, allocated resources of the clusters therein are aggregated to determine the amount of allocated resource in the zone. Within the selected zone, the placement engine 240 can select the cluster having the least amount of the allocated resource. As the VCI (and any subsequent VCIs) are placed, it is to be understood that the selected cluster and/or the zone may change as resources are allocated to newly created VCI(s).

In embodiments where zones are linked to a private cloud (e.g., and not a public cloud), the placement engine 240 can include a combination of hardware and program instructions that is configured to determine the cloud computing environment is a private cloud computing environment. Responsive to such a determination, the placement engine 240 can include a combination of hardware and program instructions that is configured to determine, for each of a plurality of cloud zones of the cloud computing environment, a respective zone proportion between an amount of the resource allocated to the customer and a total amount of the resource in the cloud zone, determine a placement cloud zone of the cloud computing environment, wherein the placement cloud zone has a smallest zone proportion from among the plurality of cloud zones, determine, for each of a plurality of clusters of the placement cloud zone, a respective cluster proportion between an amount of the resource allocated to the customer and a total amount of the resource in the cluster, and place the VCI in a cluster of the placement cloud zone having a smallest cluster proportion from among the plurality of clusters.

Stated differently, the placement engine 240 can place VCIs by resource type (e.g., memory, CPU, and/or storage) in a private cloud environment, first in the project by selecting a zone having a smallest ratio of allocated resource amount to total resource amount (referred to as “zone proportion”). Within the selected zone, the placement engine 240 can select the cluster having the smallest ratio of allocated resource amount to total resource amount (referred to as “cluster proportion”). As above, it is to be understood that the selected cluster and/or the zone may change as resources are allocated to newly created VCI(s).

In embodiments where one or more zones are linked to a public cloud and one or more zones are linked to a private cloud (e.g., a hybrid environment), the placement engine 240 can include a combination of hardware and program instructions that is configured to determine the cloud computing environment includes a plurality of public cloud zones and a plurality of private cloud zones. Responsive to such a determination, the placement engine 240 can include a combination of hardware and program instructions that is configured to determine a respective total amount of a resource in each of the plurality of private cloud zones, determine a private cloud zone from among the plurality of private cloud zones having a largest total amount of the resource, assign the largest total amount of the resource as a respective total amount of the resource for each of the plurality of public cloud zones, determine, for each of the plurality of public cloud zones and the plurality of private cloud zones of the cloud computing environment, a respective zone proportion between an amount of the resource allocated to the customer and the total amount of the resource in the cloud zone, determine a placement cloud zone of the cloud computing environment, wherein the placement cloud zone has a smallest zone proportion from among the plurality of public cloud zones and private cloud zones, determine, for each of a plurality of clusters of the placement cloud zone, a respective cluster proportion between an amount of the resource allocated to the customer and a total amount of the resource in the cluster, and place the VCI in a cluster of the placement cloud zone having a smallest cluster proportion from among the plurality of clusters.

Stated differently, the placement engine 240 can place VCIs by resource type (e.g., memory, CPU, and/or storage) in a hybrid cloud environment, first in the project by assuming each public cloud zone has a total amount of a resource equal to the amount of resource in the private cloud zone having the largest total amount of that resource. For example, if the project includes three public cloud zones and three private cloud zones (one having 1 GB of memory, one having 2 GB of memory, and one having 3 GB of memory), embodiments herein can assume that each of the three public cloud zones has a total amount of memory equal to 3 GB and assign 3 GB to each of the public cloud zones. Accordingly, embodiments herein can place VCIs without regard to an actual total amount of a resource in any of the plurality of public cloud zones. Following this assignment, embodiments herein can determine placement in a manner analogous to that discussed above in private cloud environments. For instance, the placement engine 240 can place VCIs by resource type (e.g., memory, CPU, and/or storage) in a hybrid cloud environment, first in the project by selecting a zone (public or private) having a smallest zone proportion. Within the selected zone, the placement engine 240 can select the cluster having the smallest cluster proportion. As above, it is to be understood that the selected cluster and/or the zone may change as resources are allocated to newly created VCI(s).

FIG. 3 is a diagram of a machine 346 for placement in a virtualized computing environment based on resource allocation according to one or more embodiments of the present disclosure. The machine 346 can utilize software, hardware, firmware, and/or logic to perform a number of functions. The machine 346 can be a combination of hardware and program instructions configured to perform a number of functions (e.g., actions). The hardware, for example, can include a number of processing resources 308 and a number of memory resources 310, such as a machine-readable medium (MRM) or other memory resources 310. The memory resources 310 can be internal and/or external to the machine 346 (e.g., the machine 346 can include internal memory resources and have access to external memory resources). In some embodiments, the machine 346 can be a virtual computing instance (VCI) or other computing device. The term “VCI” covers a range of computing functionality. The term “virtual machine” (VM) refers generally to an isolated user space instance, which can be executed within a virtualized environment. Other technologies aside from hardware virtualization can provide isolated user space instances, also referred to as data compute nodes. Data compute nodes may include non-virtualized physical hosts, VMs, containers that run on top of a host operating system without a hypervisor or separate operating system, and/or hypervisor kernel network interface modules, among others. Hypervisor kernel network interface modules are non-VM data compute nodes that include a network stack with a hypervisor kernel network interface and receive/transmit threads. The term “VCI” covers these examples and combinations of different types of data compute nodes, among others.

The program instructions (e.g., machine-readable instructions (MRI)) can include instructions stored on the MRM to implement a particular function (e.g., an action such as assigning resources to VCIs). The set of MRI can be executable by one or more of the processing resources 308. The memory resources 310 can be coupled to the machine 346 in a wired and/or wireless manner. For example, the memory resources 310 can be an internal memory, a portable memory, a portable disk, and/or a memory associated with another resource, e.g., enabling MRI to be transferred and/or executed across a network such as the Internet. As used herein, a “module” can include program instructions and/or hardware, but at least includes program instructions.

Memory resources 310 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory, optical memory, and/or a solid state drive (SSD), etc., as well as other types of machine-readable media.

The processing resources 308 can be coupled to the memory resources 310 via a communication path 360. The communication path 360 can be local or remote to the machine 346. Examples of a local communication path 360 can include an electronic bus internal to a machine, where the memory resources 310 are in communication with the processing resources 308 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 360 can be such that the memory resources 310 are remote from the processing resources 308, such as in a network connection between the memory resources 310 and the processing resources 308. That is, the communication path 360 can be a network connection. Examples of such a network connection can include a local area network (LAN), wide area network (WAN), personal area network (PAN), and the Internet, among others.

As shown in FIG. 3, the MRI stored in the memory resources 310 can be segmented into a number of modules 338, 340 that when executed by the processing resources 308 can perform a number of functions. As used herein a module includes a set of instructions included to perform a particular task or action. The number of modules 338, 340 can be sub-modules of other modules. For example, the placement module 340 can be a sub-module of the request module 338 and/or can be contained within a single module. Furthermore, the number of modules 338, 340 can comprise individual modules separate and distinct from one another. Examples are not limited to the specific modules 338, 340 illustrated in FIG. 3.

One or more of the number of modules 338, 340 can include program instructions and/or a combination of hardware and program instructions that, when executed by a processing resource 308, can function as a corresponding engine as described with respect to FIG. 2. For example, the placement module 340 can include program instructions and/or a combination of hardware and program instructions that, when executed by a processing resource 308, can function as the assignment engine 240.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 508 in FIG. 5. A group or plurality of similar elements or components may generally be referred to herein with a single element number. For example, a plurality of reference elements 104-1, 104-2, . . . , 104-N may be referred to generally as 104. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention, and should not be taken in a limiting sense.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A non-transitory machine-readable medium having instructions stored thereon which, when executed by a processor, cause the processor to:
receive a request made by a customer to create a virtual computing instance (VCI) of a project in cloud computing environment; and
place the VCI, wherein the instructions to place the VCI include instructions to:
responsive to determining the cloud computing environment is a public cloud computing environment:
determine a respective amount of a resource allocated to the customer in each of a plurality of cloud zones of the cloud computing environment;
determine a placement cloud zone of the cloud computing environment, wherein the placement cloud zone has a least amount of the allocated resource from among the plurality of cloud zones;
determine a respective amount of the resource allocated to the customer in each of a plurality of clusters of the placement cloud zone; and
place the VCI in a cluster of the placement cloud zone having a least amount of the allocated resource from among the plurality of clusters.

2. The medium of claim 1, wherein the resource is memory.

3. The medium of claim 1, wherein the resource is storage.

4. The medium of claim 1, wherein the resource is virtual processing.

5. The medium of claim 1, including instructions to:
determine a respective amount of a first resource allocated to the customer in each of a plurality of cloud zones of the cloud computing environment;
determine a first resource placement cloud zone of the cloud computing environment, wherein the first resource placement cloud zone has a least amount of the first allocated resource from among the plurality of cloud zones;
determine a respective amount of a second resource allocated to the customer in each of a plurality of clusters of the placement cloud zone; and
place the VCI in a cluster of the placement cloud zone having a least amount of the second allocated resource from among the plurality of clusters.

6. The medium of claim 5, wherein the first resource is one of: memory, storage, or virtual processing, and wherein the second resource is another of: memory, storage, or virtual processing.

7. The medium of claim 1, wherein each of the plurality of cloud zones is associated with a different geographical region.

8. A non-transitory machine-readable medium having instructions stored thereon which, when executed by a processor, cause the processor to:
receive a request made by a customer to create a virtual computing instance (VCI) of a project in cloud computing environment; and
place the VCI, wherein the instructions to place the VCI include instructions to:
responsive to determining the cloud computing environment is a private cloud computing environment:
determine, for each of a plurality of cloud zones of the cloud computing environment, a respective zone proportion between an amount of the resource allocated to the customer and a total amount of the resource in the cloud zone;
determine a placement cloud zone of the cloud computing environment, wherein the placement cloud zone has a smallest zone proportion from among the plurality of cloud zones;
determine, for each of a plurality of clusters of the placement cloud zone, a respective cluster proportion between an amount of the resource allocated to the customer and a total amount of the resource in the cluster; and
place the VCI in a cluster of the placement cloud zone having a smallest cluster proportion from among the plurality of clusters.

9. The medium of claim 8, wherein the resource is memory.

10. The medium of claim 8, wherein the resource is storage.

11. The medium of claim 8, wherein the resource is virtual processing.

12. The medium of claim 8, including instructions to:
determine, for each of a plurality of cloud zones of the cloud computing environment, a respective first resource zone proportion between an amount of a first resource allocated to the customer and a total amount of the first resource in the cloud zone;
determine a placement cloud zone of the cloud computing environment, wherein the placement cloud zone has a smallest first resource zone proportion from among the plurality of cloud zones;
determine, for each of a plurality of clusters of the placement cloud zone, a respective second resource cluster proportion between an amount of a second resource allocated to the customer and a total amount of the second resource in the cluster; and
place the VCI in a cluster of the placement cloud zone having a smallest second resource cluster proportion from among the plurality of clusters.

13. The medium of claim 12, wherein the first resource is one of: memory, storage, or virtual processing, and wherein the second resource is another of: memory, storage, or virtual processing.

14. A non-transitory machine-readable medium having instructions stored thereon which, when executed by a processor, cause the processor to:
receive a request made by a customer to create a virtual computing instance (VCI) of a project in cloud computing environment; and
place the VCI, wherein the instructions to place the VCI include instructions to:
responsive to determining the cloud computing environment includes a plurality of public cloud zones and a plurality of private cloud zones:
determine a respective total amount of a resource in each of the plurality of private cloud zones;
determine a private cloud zone from among the plurality of private cloud zones having a largest total amount of the resource;
assign the largest total amount of the resource as a respective total amount of the resource for each of the plurality of public cloud zones;
determine, for each of the plurality of public cloud zones and the plurality of private cloud zones of the cloud computing environment, a respective zone proportion between an amount of the resource allocated to the customer and the total amount of the resource in the cloud zone;
determine a placement cloud zone of the cloud computing environment, wherein the placement cloud zone has a smallest zone proportion from among the plurality of public cloud zones and private cloud zones;
determine, for each of a plurality of clusters of the placement cloud zone, a respective cluster proportion between an amount of the resource allocated to the customer and a total amount of the resource in the cluster; and
place the VCI in a cluster of the placement cloud zone having a smallest cluster proportion from among the plurality of clusters.

15. The medium of claim 14, wherein the resource is memory.

16. The medium of claim 14, wherein the resource is storage.

17. The medium of claim 14, wherein the resource is virtual processing.

18. The medium of claim 14, including instructions to:
determine a respective total amount of a first resource in each of the plurality of private cloud zones;
determine a private cloud zone from among the plurality of private cloud zones having a largest total amount of the first resource;
assign the largest total amount of the first resource as a respective total amount of the first resource for each of the plurality of public cloud zones;
determine, for each of the plurality of public cloud zones and the plurality of private cloud zones of the cloud computing environment, a respective first resource zone proportion between an amount of the first resource allocated to the customer and the total amount of the first resource in the cloud zone;
determine a placement cloud zone of the cloud computing environment, wherein the placement cloud zone has a smallest first resource zone proportion from among the plurality of public cloud zones and private cloud zones;
determine, for each of a plurality of clusters of the placement cloud zone, a respective second resource cluster proportion between an amount of a second resource allocated to the customer and a total amount of the second resource in the cluster; and
place the VCI in a cluster of the placement cloud zone having a smallest second resource cluster proportion from among the plurality of clusters.

19. The medium of claim 18, wherein the first resource is one of: memory, storage, or virtual processing, and wherein the second resource is another of: memory, storage, or virtual processing.

20. The medium of claim 14, including instructions to place the VCI without regard to an actual total amount of the resource in any of the plurality of public cloud zones.
